(19) United States
(12) Patent Application Publication
(10) Pub. No.: US 2023/0405447 A1
(43) Pub. Date: Dec. 21, 2023

(54) SYSTEM AND METHOD FOR PROVIDING AN INTERACTIVE, CLUE-BASED WORD PUZZLE

(71) Applicant: KRAKEN 119 PTY LTD, Morphett Vale, South Australia (AU)

(72) Inventor: Kenneth Maxwell RAWLINGS, Morphett Vale (AU)

(73) Assignee: KRAKEN 119 PTY LTD, Morphett Vale, South Australia (AU)

(21) Appl. No.: 18/036,012

(22) PCT Filed: Nov. 9, 2021
(86) PCT No.: PCT/AU2021/051321

§ 371 Date: May 9, 2023

(30) Foreign Application Priority Data
Nov. 9, 2020 (AU) 2020904080

(51) Int. Cl. A63F 3/04; A63F 13/46; A63F 13/80; A63F 13/35

(52) U.S. Cl. CPC A63F 3/0421; A63F 13/46; A63F 2003/0428; A63F 13/35; A63F 13/80

(57) ABSTRACT

The present invention relates to a computer-implemented puzzle-based game, and more particularly, to a system and method of providing and operating an interactive computer-implemented word-puzzle that is solved by selecting letters, with the assistance of clues, to create words that are linked such that the words contain letters arranged in a corresponding letter sequence.

### FIELD OF THE INVENTION

The present invention relates to a computer-implemented puzzle-based game, and more particularly, to a system and method of providing and operating an interactive computer-implemented word-puzzle that is solved by selecting letters, with the assistance of clues, to create words that are linked such that the words contain letters arranged in a corresponding letter sequence. The present invention further relates to a gaming machine and gaming device for implementing the word-puzzle.

### BACKGROUND OF THE INVENTION

Games of skill have enjoyed a significant level of popularity throughout the ages, and such games have evolved during the past century with growing technological advances. There are various different types of games, but among the most popular are “puzzle-based” games and in particular word-puzzles. Traditionally, word puzzles have been paper-based but there is increasing popularity in computer-implemented puzzles, i.e. puzzles that can be played by individuals or groups in an online environment using portable computing devices. Such puzzles may also be utilised in games involving the placement of wagers, including in online gambling and electronic gaming machines.

However, there are challenges associated with providing a successful computer-implemented word-based puzzle. For example, it is important for a word-puzzle to provide sufficient entertainment with the ability to attract the interest of players and provide them with the ability to be regularly entertained and even surprised with new puzzle twists and levels of interaction. This is often difficult to achieve using paper-based word-puzzles, which are generally incapable of being played in a number of different or new ways. Accordingly, problems arise with respect to the utilisation of known and existing techniques for providing word-puzzles. A need exists for alternative methods to provide such games in gaming systems.

It is an object of the present invention to overcome at least some of the aforementioned problems or to provide the public with a useful alternative.

The reference to any prior art in this specification is not, and should not be taken as, an acknowledgement or any suggestion, that the prior art forms part of the common general knowledge.

### SUMMARY OF THE INVENTION

In a first aspect, the present invention provides a computer-implemented method for providing a word puzzle, the method including:
storing, by one or more processors, in an internal database that includes a data structure, a plurality of words that are categorized in the data structure according to the number of letters forming each word thereby enabling the plurality of words to be arranged in groups such that each word in the same group has the same number of letters, wherein:
   each word includes one or more identification clues,
   each word in one group is linked to at least one other word in a different group according to the words having a minimum number of letters arranged in a corresponding sequence,
   each linked word having a letter count that increases sequentially by an increment of one letter from a first linked word associated with a first group of words with a minimum number of letters up to a final linked word associated with a final group of words with a maximum number of letters, each subsequent linked word beyond the first including one additional letter as compared with the preceding linked word, and
   the subsequent linked word including all letters of the preceding linked word with one additional letter at the beginning, internally, or end thereof;
receiving, by the one or more processors, from one or more user devices, a request to operate a word puzzle;
selecting, by the one or more processors, for inclusion in the word puzzle, a set of linked words which includes at least a first linked word and a final linked word;
providing, for display on the one or more user devices, a graphical user interface including:
   empty letter fields associated with a number of words that corresponds with the number of words present in the selected set of linked words, and
   an identification clue associated with one or more of the words included in the selected set of linked words to assist a user to identify each of the words and thereby spell each word by allocating letters to the empty letter fields.

In an embodiment, the method further includes automatically updating, by the one or more processors, based upon real-time or near real-time synchronization with one or more external databases, the plurality of words with new words that are present in the one or more external databases but not present in the internal database, and automatically categorizing the new words.

By automatically updating, based upon real-time or near real-time synchronization with one or more external databases (such as one or more online dictionaries), the plurality of words, the skilled addressee will appreciate that the present invention includes non-technical challenges associated with maintaining the interest of new and participating users in a word-puzzle since the words available for use in each puzzle is regularly, or continuously updated and may synchronise with the most up to date online dictionaries. Further, synchronisation together with the use of a data structure configured in the particular manner defined above gives rise to technical advantages since the particular categorisation and linking of words enables a more efficient means of retrieving those words for inclusion in a puzzle.

In a particular embodiment, the data structure of words contains six or more groups of words including a first group of two-letter words, a second group of three-letter words, a third group of four-letter words, a fourth group of five-letter words, a fifth group of six-letter words, a sixth group of seven-letter words, and this sequence continues with each additional group of words.

In this embodiment, a word in the first group is linked to a word in each of the remaining groups of the six or more groups, such that the word in the first group is the first linked word and the word in a final group of the six or more groups is the final linked word. If the puzzle is a six-word puzzle, for example, a set of linked words comprising six linked words may be selected for use in the puzzle in which case the graphical user interface will include empty letter fields associated with the selected six linked words.

As mentioned above, words are linked to form a set of linked words if they have a minimum number of letters arranged in a corresponding sequence. An example of a set of linked words include LA, LAP, LAPS, LAPSE, LAPSED and ELAPSED, which set could be used for example in a six-word puzzle. It will be appreciated that the word LAP from the three-letter group of words includes two letters arranged in the same sequence as the word LA from the two-letter group of words, the word LAPS from the four-letter group of words includes three letters arranged in the same sequence as the word LAP from the three-letter group, the word LAPSE from the five-letter group of words includes four letters arranged in the same sequence as the word LAPS from the four-letter group, the word LAPSED from the six-letter group of words includes five letters arranged in the same sequence as the word LAPSE from the five-letter group, and the word ELAPSED from the seven-letter group of words includes six letters arranged in the same sequence as the word LAPSED from the six-letter group of words.

In an embodiment, the identification clues are provided to assist the user in selecting letters for allocation to the empty letter fields. An example of identification clues that may be provided include “the sixth note” for LA, “thighs” for LAP, “circuits” for LAPS, “slip” for LAPSE, “no longer active” for “LAPSED”, and “slipped by” for ELAPSED. It is to be understood that the identification clues could include any number of different numerals, letters, words or symbols that may assist the user in identifying a word, including, for example, a synonym or a visual representation. Such identification clues may also be updated as a result of the synchronisation of the plurality of words with one or more external databases. Identification clues may also include a meaning of the word to be identified.

It will be appreciated that since clues are provided to assist the user in solving each word that is presented with empty letter fields, only one set of linked words can ultimately be selected for inclusion in the puzzle (i.e. only one solution is possible). This may vary when, for example, a clue does not accompany one or more of the words and hence there may be more than one solution in respect of at least that word or words.

In an embodiment, the method includes:
determining, based upon the set of linked words selected for inclusion in the puzzle, whether allocation of a particular letter to a particular empty letter field by a user should be accepted or rejected.

In an embodiment, rejection of a user allocation of a letter to an empty letter field causes a visual or audible alert by the corresponding user device.

In an embodiment, acceptance of a user allocation of a letter to an empty letter field causes the empty letter field to display the successfully allocated letter in the empty letter field.

In an embodiment, the graphical user interface provides the empty letter fields associated with each word from a selected set of linked words sequentially and in separate rows. For example, a first row may relate to the word in the selected set of linked words having a minimum number of letters (e.g. a two-letter word) and may increase in letters incrementally up to a final row which relates to the word in the selected set of linked words having a maximum number of letters (e.g. a seven-letter word). It will be appreciated that each word in the second and subsequent row will include the same letters that are present in the word in the preceding row, with the letters arranged in the same order. The user(s) will need to complete words in each row based upon the identification clues provided, and ensure that any new letter added to a row is placed at the beginning, internally, or at the end of the word in the preceding row. In this way, determining one or more of the missing words will assist in determining the remaining words.

In an embodiment, the graphical user interface provides the identification clue in an area adjacent the corresponding word row to enable the user to view both, and allocate any letter of the user's choosing to an empty letter field in any one row of the user's choosing.

In an embodiment, a user's “turn” is defined by the user attempting to allocate a letter to an empty letter field. The user may be provided an additional turn if the allocation of a letter to an empty letter field is determined acceptable.

In an embodiment, when the puzzle is presented to multiple users, the graphical user interface associated with the user whose turn it is will prompt the user to allocate a letter to an empty letter field.

In an embodiment, the graphical user interface across all participating devices may be synchronized across a data communications network such that all participants may observe, substantially in real-time, the attempted allocation of a letter to an empty letter field by any one participant during gameplay. In this way, it is possible for a puzzle to be played with the users physically separated by large distances.

In an embodiment, selection of a set of a set of linked words for inclusion in the puzzle is random. Selection of a set of linked words may alternatively be based upon the initial selection of a final linked word. For example, the final linked word ELAPSED may be selected for inclusion in the puzzle, and the words LA, LAP, LAPS, LAPSE, and LAPSED represent examples of words that are linked to the word ELAPSED and which may therefore be selected together with the final linked word ELAPSED as a set of linked words for inclusion in the puzzle.

In the abovementioned alternate embodiment, the plurality of words may include multiple sets having the same final linked word and hence one of many different sets of linked words having the same final linked word may be selected for inclusion in the puzzle. For example, based upon the selection of the final linked word ELAPSED, there may be additional sets of linked words in the plurality of words that may be selected to form a viable solution, e.g. LA, LAP, LAPS, LAPSE, LAPSED and ELAPSED, and PE, APE, APSE, LAPSE, LAPSED and ELAPSED. Two or more different sets of linked words having the same final linked word may be grouped together to form a multi-set of linked words, hence in addition to selecting a final word for inclusion in the puzzle, a particular set of linked words (within a multi-set) may also need to be selected. If there exists only one set of linked words for a particular final linked word, then the additional selection of a particular linked word set is not required since the single linked word set will be automatically selected.

In an embodiment, where the puzzle involves two or more competing users, the same puzzle may be presented to each user such that successful allocation of a letter by one user updates the puzzle presented to all other participating users accordingly.

In an embodiment, each set of linked words is further categorised by difficulty depending upon the difficulty level assigned to individual words included in the set of linked words as compared with other sets. The selection of a final linked word and/or one or more sets of linked words for inclusion in the puzzle may be based upon a difficulty category that is pre-selected by the user. Furthermore, there may be a number of different clue sets associated with a single set of linked words. When one or more words in a set of linked words has multiple identification clues associated therewith of varying assistance (i.e. from clues of low assistance to clues of high assistance), a single set of linked words may be categorised as having more than one difficulty level, and a clue set may be selected based upon a difficulty category pre-selected by the user.

In an embodiment involving one or more participating users, determining a winner or scoring a user's interaction with a puzzle may be based upon one or more of:
puzzle completion time;
completion of a puzzle using a minimum number of turns;
resignation by one or more opponents; and
difficulty associated with a set of linked words and/or clue set.

In an embodiment, the graphical user interface may be configured to display the scoring associated with one or more competing user's interaction with a puzzle, including one or more of:
a current score;
a final score;
a high score;
a simulated score; and
a leader board.

In an embodiment, a user may be provided with an award based upon the user's interaction with a puzzle, including for example being awarded redeemable tokens. For example, if a user identifies a word, a particular number of tokens may be allocated, and the number of tokens allocated may increase according to the number of letters associated with the identified word. Further, the number of tokens allocated may increase based upon the difficulty of words identified or difficulty of identification clue provided.

In an embodiment, tokens are redeemable to assist a user in relation to solving the puzzle. For example, a letter may be purchased using a predetermined minimum number of tokens. Further, puzzles may be generated in which particular words are provided without any associated identification clue, and tokens may be redeemable by a user to display the clue.

In a second aspect, the present invention provides a system or game controller for providing a word puzzle, the system or game controller including:
one or more memories, and
one or more processors operable to:
   store, in an internal database that includes a data structure, a plurality of words that are categorized in the data structure according to the number of letters forming each word thereby enabling the plurality of words to be arranged in groups such that each word in the same group has the same number of letters, wherein:
      each word includes one or more corresponding identification clues,
      each word in one group is linked to at least one other word in a different group according to the words having a minimum number of letters arranged in a corresponding sequence,
      each linked word having a letter count that increases sequentially by an increment of one letter from a first linked word associated with a first group of words with a minimum number of letters up to a final linked word associated with a final group of words with a maximum number of letters, each subsequent linked word beyond the first including one additional letter as compared with the preceding linked word, and
      the subsequent linked word including all letters of the preceding linked word with one additional letter at the beginning, internally, or end thereof;
      automatically update, based upon real-time or near real-time synchronization with one or more external databases, the plurality of words with new words that are present in the one or more external databases but not present in the internal database, and automatically categorize the new words;
      receive, from one or more user devices, a request to operate a word puzzle;
      select, for inclusion in the word puzzle, a set of linked words which includes at least a first linked word and a final linked word;
      provide, for display on the one or more user devices, a graphical user interface including:
         empty letter fields associated with a number of words that corresponds with the number of words present in the selected set of linked words which includes the final linked word, and
         an identification clue associated with one or more of the words included in the selected set of linked words to assist a user to identify each of the words and thereby spell each word by allocating letters to the empty letter fields.

In a third aspect, the present invention provides a computer-readable medium having a plurality of instructions executable by one or more processors to:
store, in a database that includes an internal data structure, a plurality of words that are categorized in the data structure according to the number of letters forming each word thereby enabling the plurality of words to be arranged in groups such that each word in the same group has the same number of letters, wherein:
   each word includes one or more corresponding identification clues,
   each word in one group is linked to at least one other word in a different group according to the words having a minimum number of letters arranged in a corresponding sequence,
   each linked word having a letter count that increases sequentially by an increment of one letter from a first linked word associated with a first group of words with a minimum number of letters up to a final linked word associated with a final group of words with a maximum number of letters, each subsequent linked word beyond the first including one additional letter as compared with the preceding linked word, and
   the subsequent linked word including all letters of the preceding linked word with one additional letter at the beginning, internally, or end thereof;
   automatically updating, based upon real-time or near real-time synchronization with one or more external databases, the plurality of words with new words that are present in the one or more external databases but not present in the internal database, and automatically categorizing the new words;
   receiving, from one or more user devices, a request to operate a word puzzle;
   selecting, for inclusion in the word puzzle, a set of linked words which includes at least a first linked word and a final linked word;
   providing, for display on the one or more user devices, a graphical user interface including:
      empty letter fields associated with a number of words that corresponds with the number of words present in the selected set of linked words which includes the final linked word, and
      an identification clue associated with one or more of the words included in the selected set of linked words to assist a user to identify each of the words and thereby spell each word by allocating letters to the empty letter fields.

In a fourth aspect, the present invention provides a gaming machine including:
a display;
a credit input mechanism operable to establish credits on the gaming machine, the credit input device including at least one a coin input slot and note collection device;
meters configured for monitoring credits established via the credit input mechanism and changes to the established credits due to play of the gaming machine;
a game play mechanism including a plurality of buttons configured for operation by a user to input a wager from the established credits and to initiate a play of a game; and
a game controller including a processor and memory storing game program code, the game controller executing the game program code stored in the memory and responsive to initiation of the play of the game with the game play mechanism to:
store, in an internal database that includes a data structure, a plurality of words that are categorized in the data structure according to the number of letters forming each word thereby enabling the plurality of words to be arranged in groups such that each word in the same group has the same number of letters, wherein:
   each word includes one or more corresponding identification clues,
   each word in one group is linked to at least one other word in a different group according to the words having a minimum number of letters arranged in a corresponding sequence,
   each linked word having a letter count that increases sequentially by an increment of one letter from a first linked word associated with a first group of words with a minimum number of letters up to a final linked word associated with a final group of words with a maximum number of letters, each subsequent linked word beyond the first including one additional letter as compared with the preceding linked word, and
   the subsequent linked word including all letters of the preceding linked word with one additional letter at the beginning, internally, or end thereof;
receive, via the game play mechanism, a request to operate a word puzzle;
select, for inclusion in the word puzzle using a random puzzle selector, a set of linked words which includes at least a first linked word and a final linked word;
provide, on the display, a graphical user interface including:
   empty letter fields associated with a number of words that corresponds with the number of words present in the selected set of linked words which includes the final linked word, and
   an identification clue associated with one or more of the words included in the selected set of linked words to assist a user to identify each of the words and thereby spell each word by allocating letters to the empty letter fields.

In a fifth aspect, the present invention provides a gaming device including:
a display;
a credit input means operable to establish credits on the gaming device;
a means of monitoring credits established via the credit input means and changes to the established credits due to play of the gaming device;
a game play mechanism configured for operation by a user to input a wager from the established credits and to initiate a play of a game; and
a game controller including a processor and memory storing game program code, the game controller executing the game program code stored in the memory and responsive to initiation of the play of the game with the game play mechanism to:
store, in an internal database that includes a data structure, a plurality of words that are categorized in the data structure according to the number of letters forming each word thereby enabling the plurality of words to be arranged in groups such that each word in the same group has the same number of letters, wherein:
   each word includes one or more corresponding identification clues,
   each word in one group is linked to at least one other word in a different group according to the words having a minimum number of letters arranged in a corresponding sequence,
   each linked word having a letter count that increases sequentially by an increment of one letter from a first linked word associated with a first group of words with a minimum number of letters up to a final linked word associated with a final group of words with a maximum number of letters, each subsequent linked word beyond the first including one additional letter as compared with the preceding linked word, and
   the subsequent linked word including all letters of the preceding linked word with one additional letter at the beginning, internally, or end thereof;
receive, via the game play mechanism, a request to operate a word puzzle;
select, for inclusion in the word puzzle using a random puzzle selector, a set of linked words which includes at least a first linked word and a final linked word; and
provide, on the display, a graphical user interface including:
   empty letter fields associated with a number of words that corresponds with the number of words present in the selected set of linked words which includes the final linked word, and
   an identification clue associated with one or more of the words included in the selected set of linked words to assist a user to identify each of the words and thereby spell each word by allocating letters to the empty letter fields.

### BRIEF DESCRIPTION OF THE DRAWINGS

Features of the present disclosure are illustrated by way of example and not limited in the following figure(s), in which like numerals indicate like elements, in which:

FIGS. 1A-1G illustrate an example of a graphical user interface displaying a clue-based word puzzle in accordance with an embodiment of the present invention, and an example of progression through the word puzzle by selection and allocation of letters to empty letter fields.

FIGS. 2-3 illustrate the same graphical user interface of FIG. 1 and additional examples of clues and their associated solutions.

FIG. 4 illustrates an exemplary computer-implemented system for providing a clue-based word puzzle in accordance with the present invention

FIG. 5 illustrates an exemplary flow diagram associated with the server component of the system illustrated in FIG. 4.

FIG. 6 illustrates an exemplary flow diagram of a process that enables updating of words stored in an internal database based upon real-time or near real-time synchronization with one or more external databases.

FIG. 7 illustrates an exemplary flow diagram of a process that enables a user to download and install a software application and subsequently login, or register, to use the software application for interacting with the system illustrated in FIG. 4.

FIG. 8 illustrates an exemplary flow diagram of a process that enables the user to commence a new individual game or establish a competition involving one or more opponents.

FIG. 9 illustrates an exemplary flow diagram of a process that enables the user(s) of FIG. 8 to be provided with a game puzzle and a score in respect of the users' interaction with the game puzzle.

FIG. 10 illustrates an exemplary flow diagram of a process that enables one or more administrators to adjust the way in which the puzzle game is provided to users and conduct any additional administrative tasks.

FIG. 11 illustrates a perspective view of a standalone gaming machine.

FIG. 12 illustrates a perspective view of a handheld gaming device.

### DETAILED DESCRIPTION OF THE EMBODIMENT(S) OF THE INVENTION

For simplicity and illustrative purposes, the present disclosure is described by referring to an embodiment thereof. In the following description, numerous specific details are set forth in order to provide a thorough understanding of the present disclosure. It will be readily apparent however, that the present disclosure may be practiced without limitation to these specific details. In other instances, some methods and structures have not been described in detail to avoid unnecessarily obscuring the present disclosure.

As used herein, the terms “a” and “an” are intended to denote at least one of a particular element, the term “includes” means includes but not limited to, the term “including” means including but not limited to, and the term “based on” means based at least in part on.

The present invention relates to at least a computer-implemented system and method for providing a word puzzle (220), whereby the system and method (according to one embodiment) utilize a central server (20) in communication with one or more devices (i.e. user devices (150) and administrator devices (250)). The central server (20) maintains one or more processors and/or databases for performing functions including storing, in an internal database (50) that includes a data structure, a plurality of words where each word includes one or more associated identification clues (222) to assist a user (140) in identifying the word. The plurality of words are categorized in the data structure according to the number of letters forming each word thereby enabling the plurality of words to be arranged in groups such that each word in the same group has the same number of letters. Each word in one group is linked to at least one other word in a different group according to the words having a minimum number of letters arranged in a corresponding sequence.

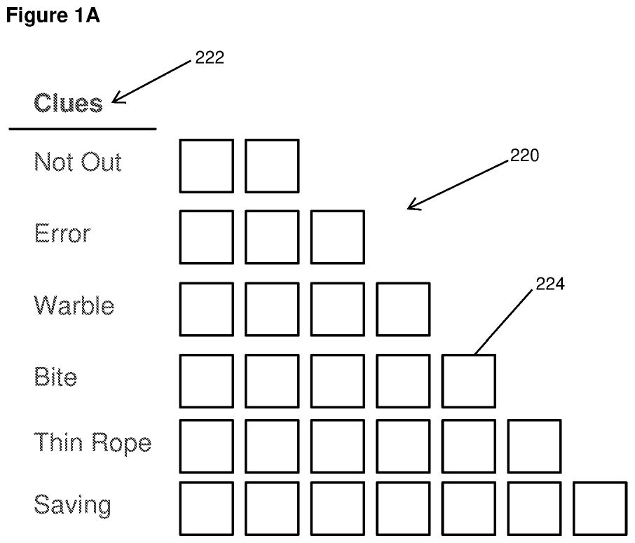

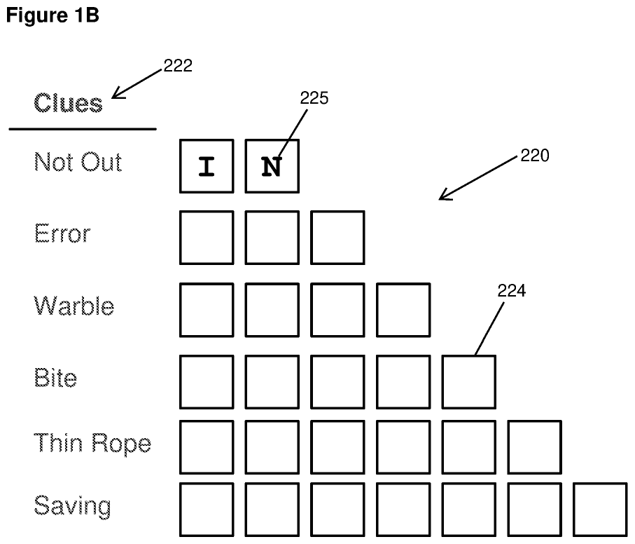

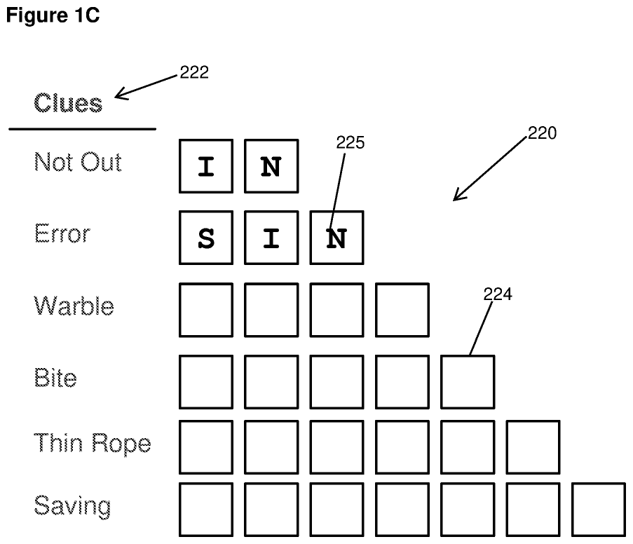

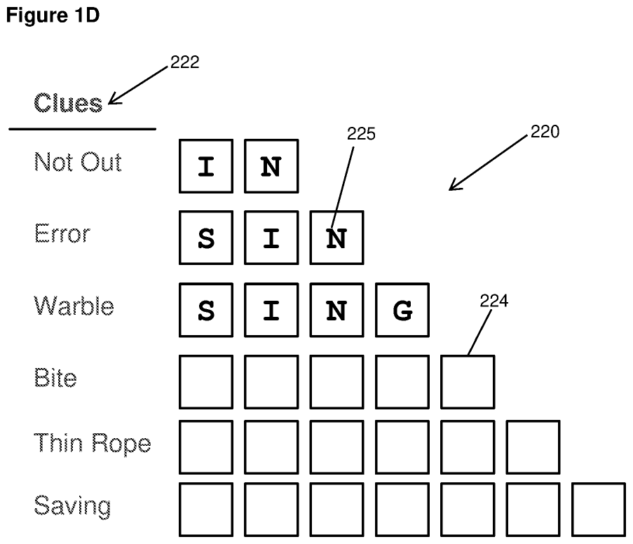

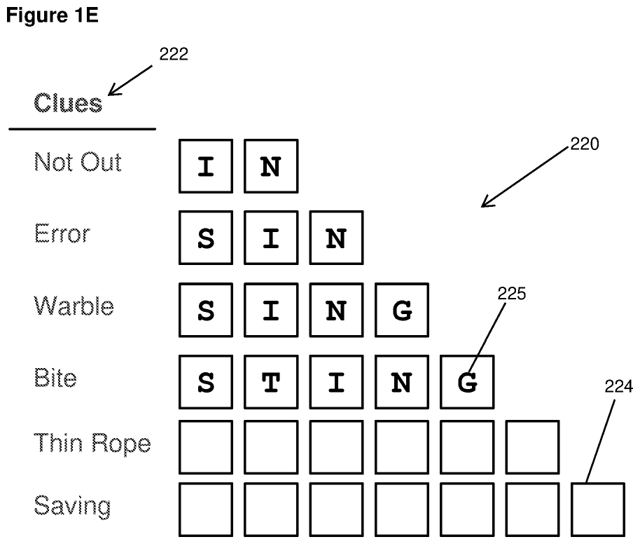

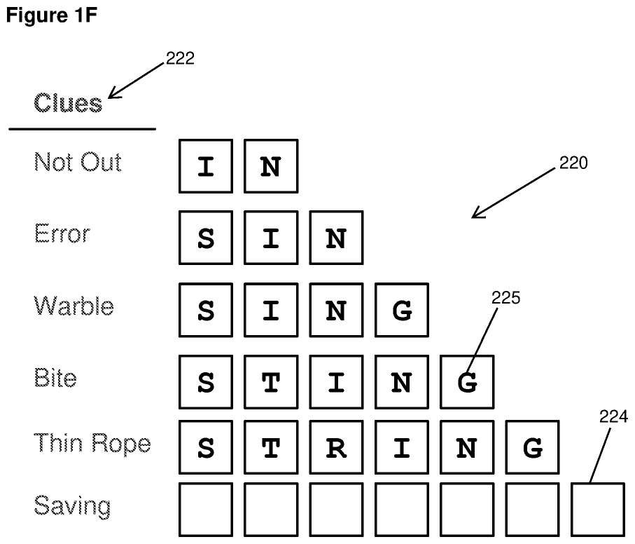

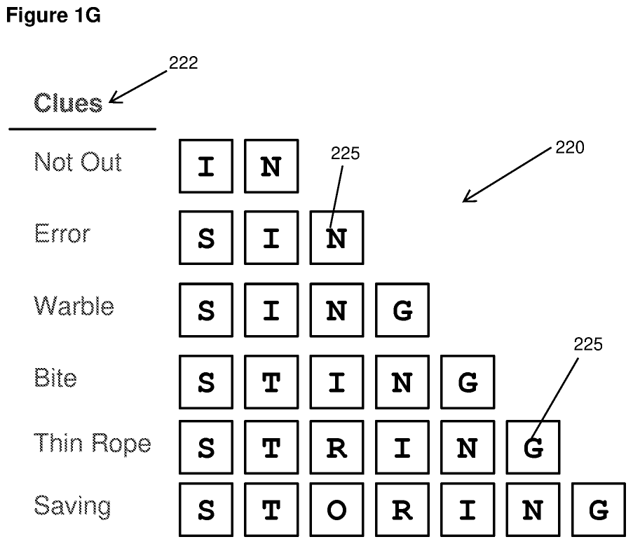

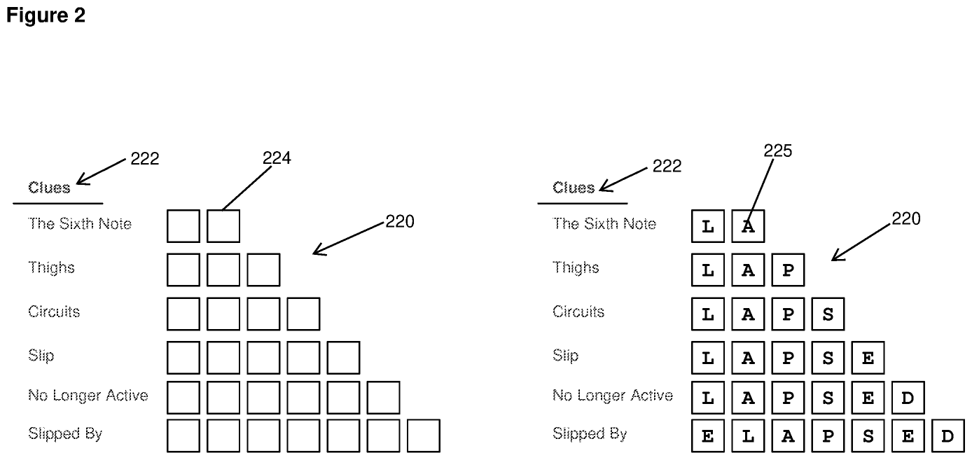

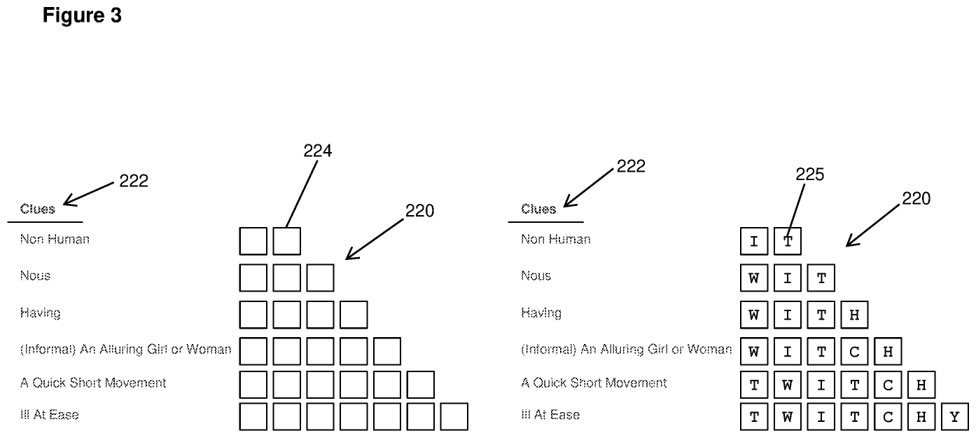

Each linked word has a letter count that increases sequentially by an increment of one letter from a first linked word associated with a first group of words having a minimum number of letters up to a final linked word associated with a final group of words having a maximum number of letters, each subsequent linked word beyond the first including one additional letter as compared with the preceding linked word. The subsequent linked word includes all letters of the preceding linked word with one additional letter at the beginning, internally, or an end thereof. In the solution to the example puzzle (220) shown in FIGS. 1A to 1G, it will be appreciated that the first linked word is IN which is selected from a first group of two-letter words, and the final linked word is STORING which is selected from a final group of seven-letter words, with each subsequent linked word beyond the first being SIN, SING, STING and STRING which include one additional letter as compared with the preceding linked word at the beginning, internally or at an end thereof. Additional examples of linked word sets (solutions) are provided in FIGS. 2 and 3.

The central server (20) is further configured to automatically update, based upon real-time or near real-time synchronization with one or more external databases (130), the plurality of words with new words that are present in the one or more external databases (130) but not present in the internal database (50), and automatically categorize the new words in the relevant group. For example, if the new word is a two-letter word, it will be categorized in the two-letter group of words, and words in other groups will be linked to the new two-letter word according to the above-described criteria to create a new set of linked words. In this regard, the server (20) may operate a synchronization module for the purpose of automatically synchronizing database (50) with the one or more external databases (130), and machine learning techniques may be utilized to learn from previous synchronization/categorization successes and/or failures in order to enable the synchronization/categorization process to become more accurate and effective over time.

When a request to operate a word puzzle game is received from a user or users (140), e.g. utilizing an application (160) operating on their device(s) (150), a set of linked words which includes at least a first linked word and a final linked word is selected (e.g. randomly) for inclusion in the word puzzle. For example, the server (20) may operate a random puzzle selector for the purpose of randomly selecting a set of linked words for use in a puzzle game. The server (20) may then provide, for display on the user device (150), a graphical user interface displaying a puzzle game (220) including empty letter fields (224) associated with a number of words that corresponds with the number of words present in the selected set of linked words, as well as an identification clue (222) associated with one or more of the words included in the selected set of linked words to assist a user to identify each of the words and thereby spell each word by allocating letters (225) to the empty letter fields (224).

Accordingly, the present invention seeks to challenge users to solve a word puzzle by identifying a string of words, where each word builds on the previous word, by selecting and allocating letters (225) to empty letter word fields (224) based upon clues (222) that are presented to the user (140) in association with one or more of the words.

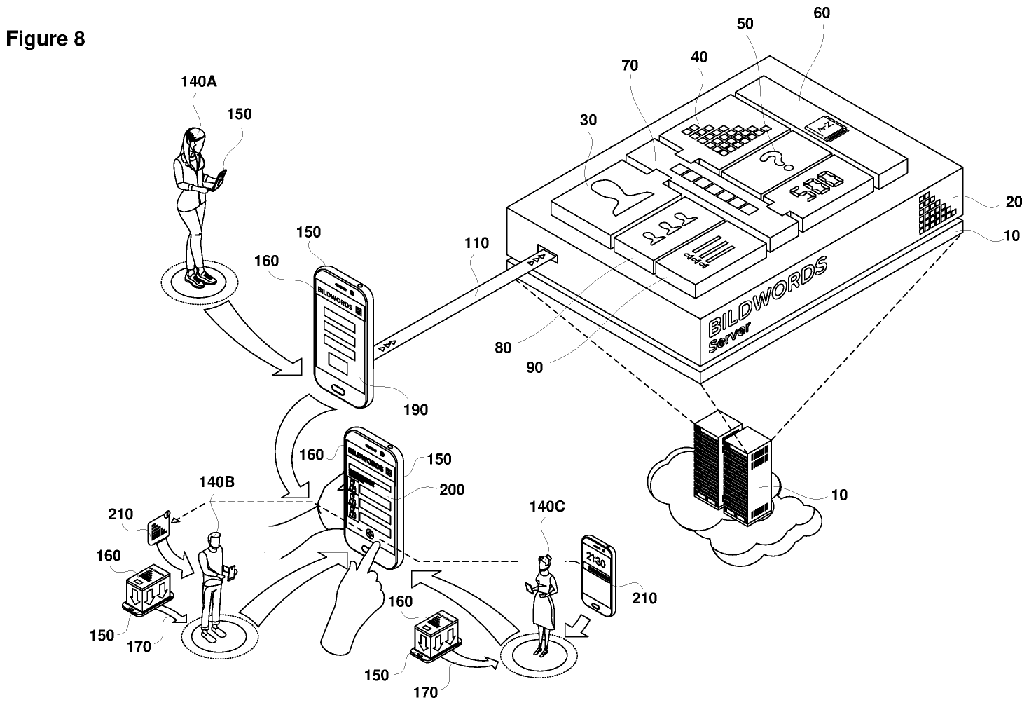

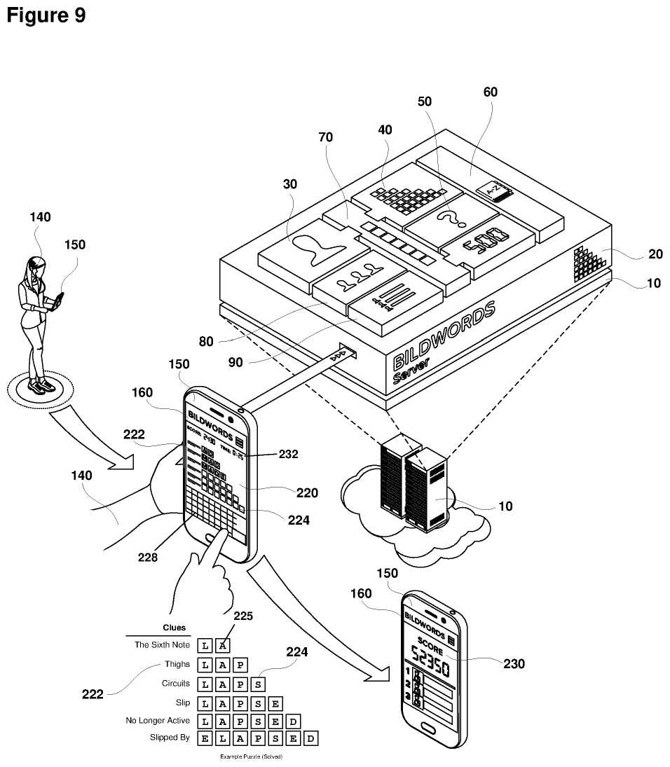

Examples of graphical user interfaces displaying word puzzles (220) in accordance with an embodiment of the present invention are shown in FIGS. 1A-1G, as well as FIGS. 2-3. These will be described in greater detail below with reference to FIGS. 8-9 which illustrate the user (140) initiating a puzzle game and then interacting with same.

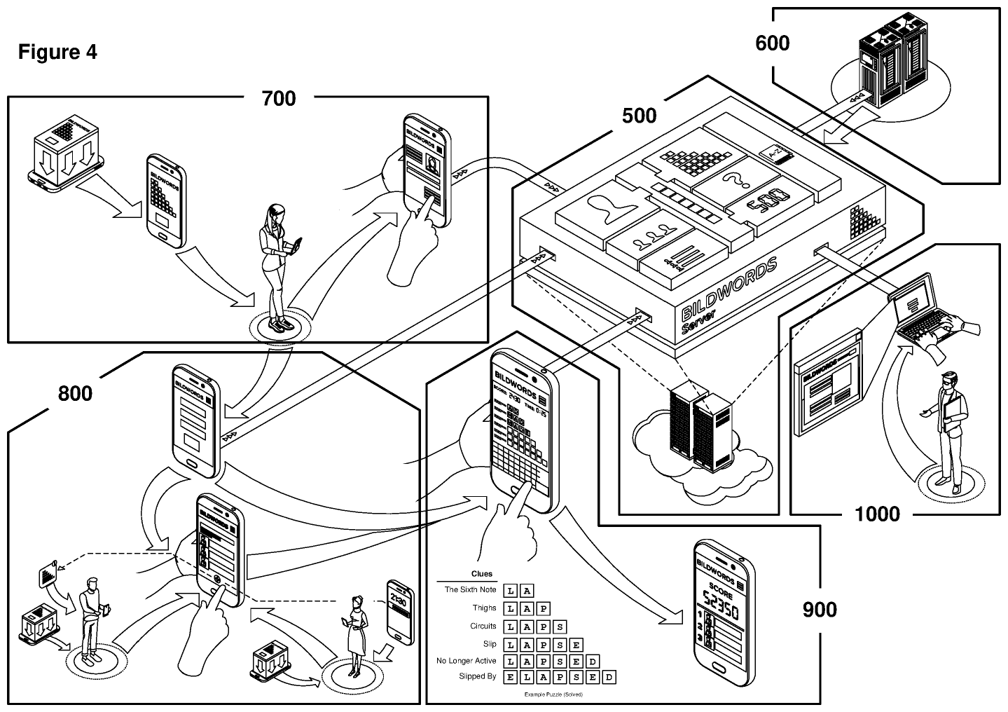

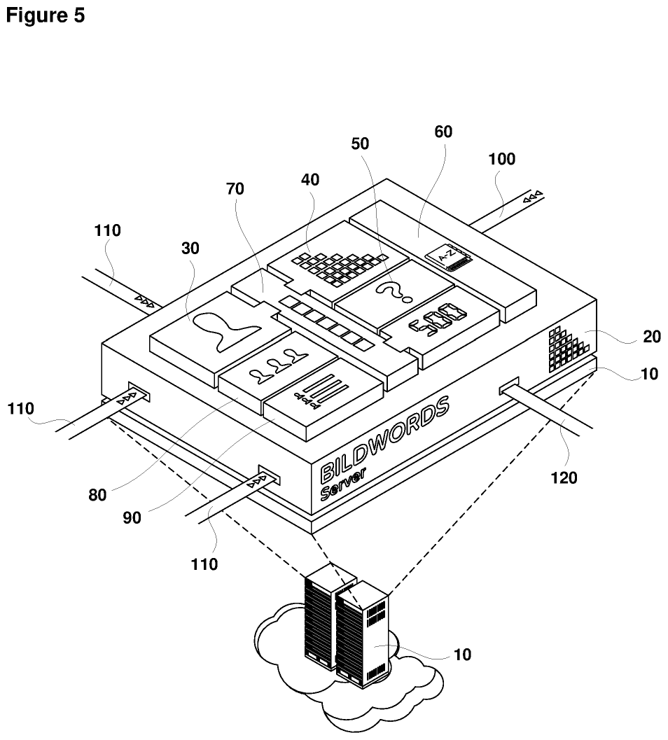

FIG. 4 is divided into segments which are further expanded in the subsequent FIGS. 5 to 10. In particular, segment 500 of FIG. 4 shows a server component (20) with which the software application (160) operating on the user device(s) (150) is configured to communicate. This is expanded in FIG. 5, and the skilled person will appreciate that the steps described herein with respect to this embodiment may be carried out using the software application (160) that operates on each user device (150) such as a mobile phone, or any other appropriate application. For example, a software application operating on a computer such as a desktop computer or laptop could also be used.

As an alternative or in addition to steps being carried out by one or more processors associated with user device (150), steps may also be carried out by one or more processors associated with the server (20). For example, the server (20) could be programmed to provide any functions described herein that cannot be provided locally on the user device(s) (150).

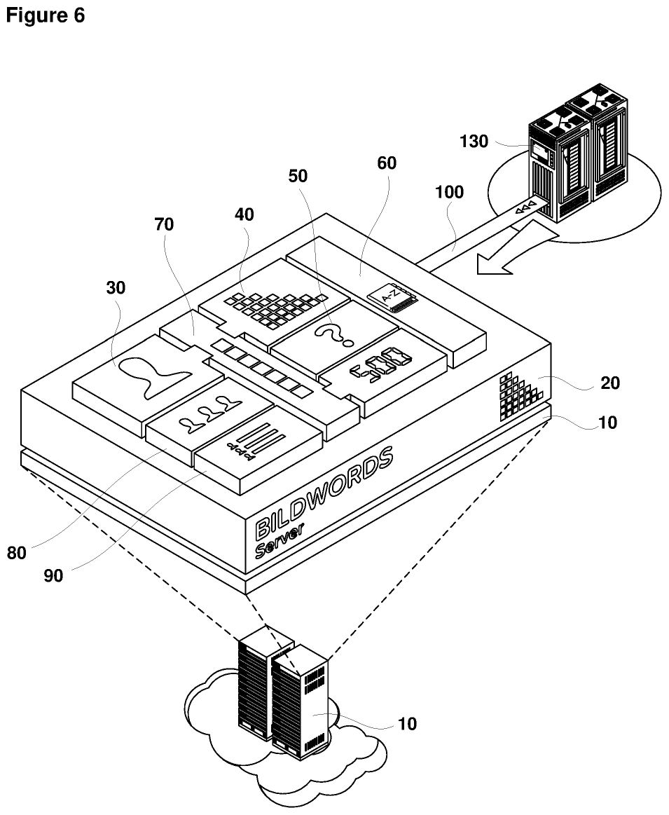

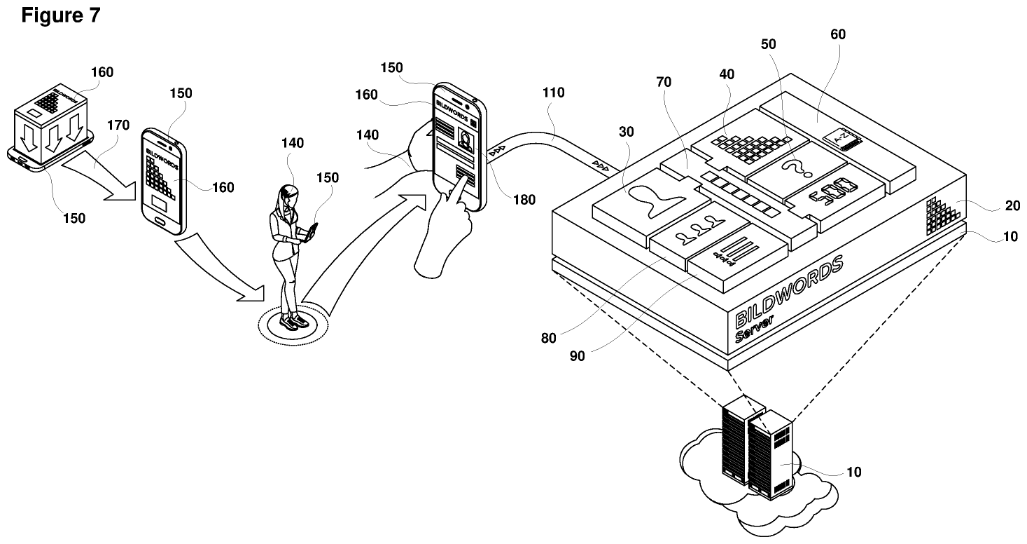

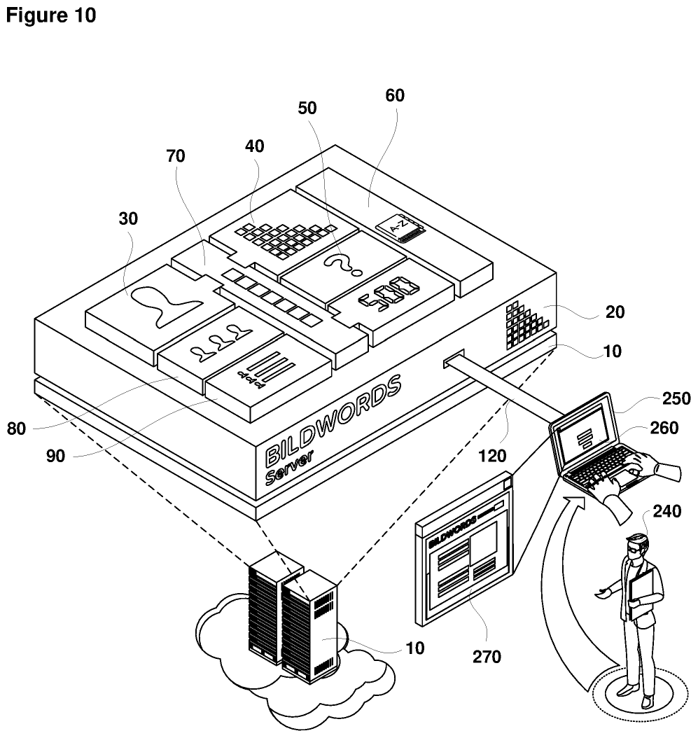

By way of example, segment 600 of FIG. 4 shows the server (20) being caused to communicate with external database(s) (130) relating to one or more online dictionaries, which is expanded in FIG. 6. Segment 700 of FIG. 4 shows a user (140) downloading and installing the application (160) and subsequently logging into the user application (160), which is expanded in FIG. 7. Segment 800 of FIG. 4 illustrates an example of a user (140A) initiating a new individual puzzle game or inviting additional participants (140B and 140C) to join in a competition, as expanded in FIG. 8. Segment 900 of FIG. 4 illustrates the user (140) interacting with a generated interface (220) displaying a word puzzle (220), as expanded in FIG. 9. Finally, segment 1000 of FIG. 4 is expanded in FIG. 10 and shows the server (20) being caused to communicate with an administrator device (250) via an administrator application (260).

As mentioned above, FIG. 5 shows in greater detail the segment 500 from FIG. 4. In particular, FIG. 5 shows the server component (20) which includes infrastructure (10) upon which the platform of the present embodiment operates. The infrastructure (10) may be local or cloud-based. The central server (20) may operate one or more computer applications and maintain one or more databases that enable the following functionality and/or storage:
User Account Register (30) storing accounts relating to users (e.g. 140, 140A, 140B, 140C) who have registered to use the application (160), each user account including a user profile comprising key information about the registered participant, including name, address, and credentials such as username and password;
Game Controller (40) that enables puzzles to be generated in accordance with the method described herein, which may utilise a random puzzle selector and one or more algorithms that enable the categorisation and retrieval of words and associated clues to generate puzzles and solutions;
Database (50) including a data structure for storing the plurality of categorised words and clues for selection during puzzle generation;
Dictionary Information Repository (60) including dictionaries already referenced by words present in the internal database (50) and information relating to the version of each dictionary to assist in determining whether the version is the most up to date or requires updating;
Game Data Repository (70) which stores details about game instances, including for example details relating to participants, time taken to complete a puzzle, number of correct/incorrect selections, any wagers placed, and scores; and
one or more additional repositories for storing relevant information, including for example repository (80) for storing competition related information, and repository (90) for storing leader board information, e.g. ranking of users based on scores.

It is to be understood that despite there being multiple means of data storage described above, this is by way of example only. For example, in an alternative embodiment, all data could be stored in a single repository that is suitably indexed such that data can be easily extracted.

FIG. 5 also shows that the server (20) in this embodiment is configured to enable communication (110) with the user device(s) (150), in particular the user application (160) operating on the user device(s) (150), as well as communication (120) with the administrator application (260) operating on administrator device(s) (250), through use of a data communications network such as the internet or similar network. The server (20) in FIG. 5 also shows a means of communicating (100) with one or more external databases, such as external databases (130) relating to online dictionaries, which enables synchronisation of words stored in the internal database (50) with words present in the external databases (130). Such synchronisation may occur automatically at regular intervals, or may need to be initiated by an administrator (240).

Clues stored in database (50) may also be synchronised in a similar manner. For example, a clue (222) may be in the form of a dictionary meaning or synonym, and in addition to storing the words themselves, online dictionaries will typically store additional information including meanings, synonyms and antonyms associated with particular words. Accordingly, where a clue is required to be allocated to a word automatically (e.g. where such a clue is not manually entered by the administrator (240)), such clues may be sourced from the online dictionary or any other external source. An example of a meaning clue is “thin rope” associated with the word “string”, and an example of a synonym clue is the word “thighs” associated with the word “lap”.

FIG. 6 shows in greater detail segment 600 of FIG. 4 and, in particular, the interface and transfer/synchronisation of data that may occur between the server (20) and the one or more external databases (130) when the present embodiment is implemented. As mentioned previously, new words and clues that are present in the one or more external databases (130) but not present in the internal database (50) may be retrieved and stored in the data structure and automatically categorized according to the above-described criteria.

FIG. 7 shows a user device (150) being operated by the user (140) to install the application (160), which may be achieved by downloading the application (160) from an applicable application store. The user (140) may create an account using the application (160) and the account information may be stored in the user account register (30). In addition to name, address and credentials, the account register (30) may also store user preferences such as a selected avatar or photo for display on competition leaderboards and the like, particular dictionaries selected by the user which may limit the words/clues that are selectable from the database (50) for inclusion in the puzzle, and the user's preference regarding puzzle difficultly.

The user account may capture information sufficient to enable the user (140) to be correctly identified, as described above. The process of installing the application (160) is indicated by arrow (170), and an example interface which enables the user (140) to login or register to use the application (160) is indicated by reference numeral (180). A similar registration/login process may apply to administrators (240) using an administrator application (260) operating on an administrator device (250).

FIG. 8 illustrates an example of a user (140A) initiating a puzzle game as well as a competition involving additional participants (140B, 140C) who have also downloaded and installed application (160) on their respective devices (150). Once registered, a user can commence a new game and may be presented with a new single game interface (190) which allows the user to select options that have not been selected previously in user preferences. Such options may include, for example, the dictionaries that will be used, whether the user is competing against others or playing alone, and whether game time limits apply.

If the user (140A) prefers to compete against other users (140B, 140C), such as their friends for example, they can invite additional registered participants to a competition. Alternatively, users can choose to compete against a random set of other users, in which case the user (140A) may be presented with a competition game interface (200). In this regard, the server (20) may operate a random user selector for randomly selecting registered users to compete against user (140A), and this selection may be further based upon preferences of user (140A) (e.g. user (140A) is female and prefers to compete against other females, or user (140A) is university qualified and prefers to compete against other users who are university qualified, etc). When other users (140B, 140C) are invited to compete, they may receive a notification (210) which they can either accept or reject. Users may receive such notifications either via the application (160), or if they don't have the application (160) operating on their device (150), they may be invited to download and install the application 160 via a text message or email.

FIG. 9 illustrates a user (140) interacting with a puzzle game interface (220) after a “single user” game has been initiated. The puzzle game (220) shown is an example of a game in which the empty letter fields (224) associated with each word from a selected set of linked words appear sequentially and in separate rows. The first row relates to the word in a selected set of linked words having a minimum number of letters (in this example, two letters), and each row thereafter increases in letters incrementally up to a final row which relates to a final linked word in the selected set of linked words having a maximum number of letters (in this case, seven letters). It will be appreciated that each word in the second and subsequent row includes the same letters that are present in the word in the preceding row, with the letters arranged in the same order. The user (140) therefore needs to complete words in each row with the assistance of clues (222) alongside each word, and ensure that any new letter added to a row is placed at the beginning, internally, or at the end of the word in the preceding row. In this way, determining one or more of the missing words will assist in determining the remaining words.

The graphical user interface (220) provides clues (222) in an area adjacent the rows to enable the user (140) to view the clue and associated empty letter fields (224), and the user is then invited to type a letter (225) in an empty letter field (224) in any one available row of the user's choosing. For example, the graphical user interface (220) may be configured to enable the user to type directly into an empty letter field (224) by clicking on the empty letter field and using a keypad (228) to type a letter.

When a game commences, the user (140) will be presented with the set of rows and associated clues (222), and the user (140) will need to create a sequence of words where each word builds upon the word in the previous row (although it is to be understood that the empty letter words could be presented in other arrangements, and not necessarily rows). Letters must stay in the same sequence with one letter added to make the next word in the sequence. The one letter may be added at either the start, inside or at the end of the previous word. In instances where a clue is presented alongside a word, the skilled addressee will appreciate that there is only one possible word solution for that row.

An example of a puzzle game (220) is shown in FIGS. 1A-1G in which the clues “Not Out”, “Error”, “Warble”, “Bite”, “Thin Rope” and “Saving” are displayed along with six rows of empty letter word fields starting from a first word comprising two letters up to a final word that is linked to the first word comprising seven letters. This is an example of a “six-word” puzzle game. The solutions associated with each of the clues is, respectively, IN, SIN, SING, STING, STRING and STORING. It is to be understood that the empty letter fields (224) need not be limited to letters, but could include any symbol required to complete a particular word.

The completed puzzles (220) shown in FIGS. 2-3 represent examples of additional puzzles, in which it will be appreciated that the user must identify the words LA, LAP, LAPS, LAPSE, LAPSED and ELAPSED based upon the presentation of respective clues “The Sixth Note”, “Thighs”, “Circuits”, “Slip”, “No Longer Active” and “Slipped By”, and similarly, the words IT, WIT, WITH, WITCH, TWITCH and TWITCHY based upon the presentation of respective clues “Non Human”, “Nous”, “Having”, “(Informal) An Alluring Girl or Woman”, “A Quick Short Movement”, and “Ill At Ease”.

It is to be understood that FIGS. 1-3 represent puzzles and interfaces by way of example only, and that the puzzles and interfaces may well vary (including in relation to the number of letters in the first and final linked words and hence the number of words required to be solved in the puzzle, and the number and type of clues provided.

FIG. 9 also shows an example of a score and leader board interface (230) which shows the final score following completion of a puzzle (either individual or multiple scores depending upon the number of participants), and any additional relevant information such as the winner (in the event of a competition) and the time take to complete the puzzle. In this regard, as shown in interface (160), the user (140) may be provided with a timer (232) to enable the user (140) to understand how much time is being consumed for a particular game and/or particular turn of the user (140). High scores may also be displayed.

FIG. 10 shows a game administrator (240) interacting with an administrator application (260) operating on their device (250), and an example interface (270) which enables the administrator (240) to perform administrator tasks including, but not limited to, making adjustments to the game and correcting any errors.

An aim of the puzzle may be not only to solve the puzzle but to do so in a manner that satisfies a scoring criteria including in relation to puzzle difficulty, time taken, etc. In this regard, determining a winner or scoring and awarding a user's interaction with a puzzle may be based upon a number of different factors, including one or more of puzzle completion time, completion of a puzzle using a minimum number of turns, resignation by one or more opponents, and difficulty associated with a set of linked words and/or clues. Users can compete on their own by trying to better their score or against others via online competitions. Where the puzzle involves two or more competing users, the same puzzle may be presented to each user such that successful allocation of a letter by one user updates the puzzle presented to all other participating users accordingly.

As mentioned previously, each set of linked words may be further categorised by difficulty depending upon the difficulty level assigned to individual words included in the set of linked words as compared with other sets. The selection of one or more sets of linked words for inclusion in the puzzle (or a final linked word according to the alternative embodiment) may be based upon a difficulty category that is pre-selected by the user (140). Furthermore, there may be a number of different clue sets associated with a single set of linked words. When one or more words in a set of linked words has multiple identification clues associated therewith of varying assistance (i.e. from clues of low assistance to clues of high assistance), a single set of linked words may be categorised as having more than one difficulty level, and a clue set may be selected based upon a difficulty category pre-selected by the user (140).

A user may be provided with an award based upon the user's interaction with a puzzle, including for example being awarded redeemable tokens, or credit if a user has placed a wager in respect of the game (as described in greater detail below). For example, if a user (140) identifies a word, a particular number of tokens or credit may be allocated, and the number of tokens or credit allocated may increase according to the number of letters associated with the identified word. Furthermore, the number of tokens or credit allocated may increase based upon the difficulty of words identified or the difficulty of the identification clue provided. Tokens or credit may be redeemable to assist the user (140) in relation to solving the puzzle. For example, a letter may be purchased using a predetermined minimum number of tokens or credit. Further, new puzzles may be generated in which particular words are provided without any associated identification clue, and tokens or credit may be redeemable by a user (140) to display the clue.

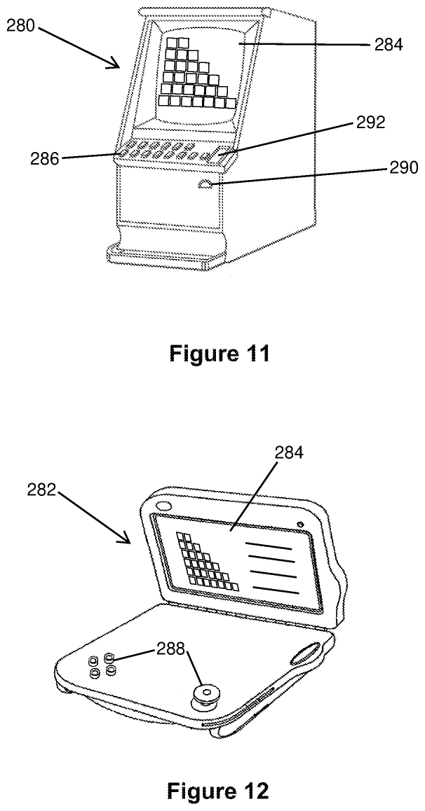

It will be appreciated that the gaming system upon which the puzzle game (220) can be played can take a number of different forms. In one form, the gaming system may utilise the system components shown in FIG. 4 and described above. However, the gaming system could also take the form of a standalone gaming machine (280), as shown in FIG. 11, or a handheld gaming device (282), as shown in FIG. 12. In these additional forms, all or most components required for implementing the game may be present in the machine/device, or a distributed architecture may be provided in which some of the components required for implementing the game are present in the machine/device whilst some components are located remotely, e.g. in an associated server component such as server (20).

Where features in these additional embodiments are the same or perform similar functions as features that have been previously described with respect to the system of FIG. 4, the same reference numerals will be used. Similarly, if any features have been described with respect to the previously described embodiment, even if they are not expressly described again with respect to machine (280) and device (282), it is to be understood that they may well form part of machine (280) and device (282).

Irrespective of how the game is implemented, the hardware utilised in the gaming system will include, at the broadest level, an interface (e.g. the previously described interface (160), and screens (284) associated with the machine (280) and device (282)) and a controller (e.g. the previously described game controller (40), noting that each of machine (280) and device (282) include or are linked to similar controllers (not shown)). If the game (220) is configured to enable the placement of wagers, i.e. where a single or multiple players place a wager on solving the puzzle, or on the basis that the player or players achieve some other goal associated with the game, the system may include the necessary components to enable same. For example, in addition to including a screen (284) for displaying representations of the puzzle game (220) including the empty letter fields (224) and clues (222), the machine (280) and device (282) include a means of enabling the player to interact (e.g. a bank of buttons (286) as shown on gaming machine (280), and a joystick and associated buttons (288) as shown on gaming device (282)).

Additional hardware may be included the machine (280) and/or device (282) to enable players to input “credit” which enables the placement of wagers. For example, the machine (280) includes a coin slot (290) and note collection device (292) which enable the player to input credit and then place wagers utilising the credit. Other means of inputting credit may also be incorporated into the machine (280) or device (282) which are not shown, including for example the use of tickets or cards held by the player. Since device (282) does not include credit input hardware, it may utilise other means of recognising credit input by the player by other means (e.g. by using an associated software application on a smart device that includes a payment gateway enabling credit to be generated in exchange for funds that are transferred electronically from a financial institution associated with the player). Once credit is input, wagers may be deducted from the credit (e.g. from a credit meter) when a game commences.

Each attempt at adding a letter (225) to an empty letter field 224 may constitute a game round, and for each game round, the game controller (40) may determine the outcome of the round (e.g. whether the player selected a correct letter for the selected empty letter field. If the outcome of the round is a losing outcome, then a single player may be provider another turn (i.e. another round), or the next round may involve another player if multiple players are competing in a multiplayer competition. If the outcome of a round is a winning outcome, then a monetary award may be payable to the particular player (and accumulated until the puzzle has been completed). Alternatively, only players who win the entire puzzle will be awarded.

The screen (284) on the machine (280) may be in the form of a video display unit, e.g. a cathode ray tube screen. However, the screens (284) on each of the machine (280) and device (282) may utilise any suitable display technology, such as a Liquid Crystal Display (LCD) or plasma screen, and the screens may also be configured as touch screens.

Whilst not shown, the game controller (40) associated with gaming machine (280) may include a processor mounted on a circuit board, whereby instructions and data to control operation of the processor are stored in a memory, which is in data communication with the processor. The previously described selectors (i.e. the random puzzle selector for randomly selecting a set of linked words for use in the puzzle, and random user selector) may be in the form of modules that generate the requisite words and users for use by the processor. It is to be understood that the gaming machine (280) and device (282) may include additional features, such as hardware meters (e.g. credit meters), input/output interfaces, communications interface, and other intelligent devices, which are not shown or described herein for the purpose of brevity.

As used herein, the term “central server”, “computer”, “computing system” or the like may include any processor-based or microprocessor-based system including systems using microcontrollers, reduced instruction set computers (RISC), application specific integrated circuits (ASICs), logic circuits, and any other circuit or processor including hardware, software, or a combination thereof capable of executing the functions described herein. Such are exemplary only, and are thus not intended to limit in any way the definition and/or meaning of such terms.

The one or more processors as described herein are configured to execute a set of instructions that are stored in one or more data storage units or elements (such as one or more memories), in order to process data. For example, the one or more processors may include or be coupled to one or more memories. The data storage units may also store data or other information as desired or needed. The data storage units may be in the form of an information source or a physical memory element within a processing machine. An example of memory used in the gaming machine (280) for example includes RAM, EPROM and a mass storage device where the RAM holds program files for execution by the processor, and the EPROM is a boot ROM device or may contain some system or game code.

The set of instructions may include various commands that instruct the one or more processors to perform specific operations such as the methods and processes of the various embodiments of the subject matter described herein. The set of instructions may be in the form of a software program. The software may be in various forms such as system software or application software. Further, the software may be in the form of a collection of separate programs, a program subset within a larger program or a portion of a program. The software may also include modular programming in the form of object-oriented programming. The processing of input data by the processing machine may be in response to user commands, or in response to results of previous processing, or in response to a request made by another processing machine.

The diagrams of embodiments herein illustrate one or more control or processing units. It is to be understood that the processing or control units may represent circuits, circuitry, or portions thereof that may be implemented as hardware with associated instructions (e.g., software stored on a tangible and non-transitory computer readable storage medium, such as a computer hard drive, ROM, RAM, or the like) that perform the operations described herein. The hardware may include state machine circuitry hardwired to perform the functions described herein. Optionally, the hardware may include electronic circuits that include and/or are connected to one or more logic-based devices, such as microprocessors, processors, controllers, or the like.

Optionally, the one or more processors may represent processing circuitry such as one or more of a field programmable gate array (FPGA), application specific integrated circuit (ASIC), microprocessor(s), and/or the like. The circuits in various embodiments may be configured to execute one or more algorithms to perform functions described herein. The one or more algorithms may include aspects of embodiments disclosed herein, whether or not expressly identified in the figures or a described method.

Throughout this specification and claims which follow, unless the context requires otherwise, the word “comprise”, and variations such as “comprises” and “comprising”, will be understood to mean the inclusion of a stated feature or step, or group of features or steps, but not the exclusion of any other feature or step, or group of features or steps.

The reference to any prior art in this specification is not, and should not be taken as, an acknowledgement or any suggestion that the prior art forms part of the common general knowledge.

1. A computer-implemented method for providing a word puzzle, the method including:
storing, by one or more processors, in an internal database that includes a data structure, a plurality of words that are categorized in the data structure according to the number of letters forming each word thereby enabling the plurality of words to be arranged in groups such that each word in the same group has the same number of letters, wherein:
each word includes one or more identification clues,
each word in one group is linked to at least one other word in a different group according to the words having a minimum number of letters arranged in a corresponding sequence,
each linked word having a letter count that increases sequentially by an increment of one letter from a first linked word associated with a first group of words with a minimum number of letters up to a final linked word associated with a final group of words with a maximum number of letters, each subsequent linked word beyond the first including one additional letter as compared with the preceding linked word, and
the subsequent linked word including all letters of the preceding linked word with one additional letter at the beginning, internally, or end thereof;
receiving, by the one or more processors, from one or more user devices, a request to operate a word puzzle;
selecting, by a game module associated with the one or more processors, for inclusion in the word puzzle, a set of linked words which includes at least a first linked word and a final linked word;
providing, for display on the one or more user devices, a graphical user interface including:
empty letter fields associated with a number of words that corresponds with the number of words present in the selected set of linked words, and
an identification clue associated with one or more of the words included in the selected set of linked words to assist a user to identify each of the words and thereby spell each word by allocating letters to the empty letter fields.

2. A computer-implemented method according to claim 1, further including:
automatically updating, by the one or more processors, based upon real-time or near real-time synchronization with one or more external databases, the plurality of words with new words that are present in the one or more external databases but not present in the internal database, and automatically categorizing the new words.

3. A computer-implemented method according to either claim 1 or claim 2, wherein the data structure of words contains six or more groups of words including a first group of two-letter words, a second group of three-letter words, a third group of four-letter words, a fourth group of five-letter words, a fifth group of six-letter words, a sixth group of seven-letter words.

4. A computer-implemented method according to claim 3, wherein a word in the first group is linked to a word in each of the remaining groups of the six or more groups, such that the word in the first group is the first linked word and the word in a final group of the six or more groups is the final linked word.

5. A computer-implemented method according to claim 4, wherein the puzzle is a six-word puzzle, and a set of linked words comprising six linked words is selected by the game controller for use in the puzzle and the graphical user interface displays empty letter fields associated with the selected six linked words.

6. A computer-implemented method according to any one of the preceding claims, wherein the identification clues include a numerals, letters, words and/or symbols that assist the user in identifying a word, and include one or more of:
a dictionary meaning of the word,
a synonym associated with the word,
an antonym associated with the word, and
a visual representation of the word.

7. A computer-implemented method according to any one of claims 2 to 6, wherein the identification clues are updated as a result of the synchronisation of the plurality of words with one or more external databases.

8. A computer-implemented method according to any one of the preceding claims, further including:
determining, based upon the set of linked words selected for inclusion in the puzzle, whether allocation of a particular letter to a particular empty letter field by a user is correct and should therefore be accepted, or incorrect and should therefore be rejected.

9. A computer-implemented method according to claim 8, wherein rejection of a user allocation of a letter to an empty letter field causes a visual or audible alert by the corresponding user device.

10. A computer-implemented method according to either claim 8 or claim 9, wherein acceptance of a user allocation of a letter to an empty letter field causes the empty letter field to display the successfully allocated letter in the empty letter field.

11. A computer-implemented method according to any one of the preceding claims, wherein the graphical user interface displays the empty letter fields associated with each word from the selected set of linked words sequentially and in separate rows, whereby a first row relates to the word in the selected set of linked words having a minimum number of letters, and there is an incremental increase in letters up to a final row which relates to the word in the selected set of linked words having a maximum number of letters.

12. A computer-implemented method according to claim 11, wherein each word in the second and subsequent row includes the same letters that are present in the word in the preceding row, with the letters arranged in the same order, hence a user is required to complete words in each row based upon the identification clues provided and ensure that any new letter added to a row is placed at the beginning, internally, or at the end of the word in the preceding row.

13. A computer-implemented method according to either claim 11 or claim 12, wherein the graphical user interface provides the identification clue in an area adjacent the corresponding word row to enable the user to allocate any letter of the user's choosing to an empty letter field in any one row of the user's choosing.

14. A computer-implemented method according to any one of the preceding claims, wherein the user is provided an additional turn if the allocation of a letter to an empty letter field is determined acceptable.

15. A computer-implemented method according to any one of the preceding claims, wherein the puzzle is presented to multiple users, and the graphical user interface associated with the user whose turn it is will prompt the user to allocate a letter to an empty letter field.

16. A computer-implemented method according to claim 15, wherein the graphical user interface across all participating devices is synchronized across a data communications network such that all participants observe, substantially in real-time, the attempted allocation of a letter to an empty letter field by any one participant during gameplay, and successful allocation of a letter by one user updates the puzzle presented to all other participating users accordingly.

17. A computer-implemented method according to any one of the preceding claims, wherein selection of a set of a set of linked words for inclusion in the puzzle is random.

18. A computer-implemented method according to claim 17, wherein each set of linked words is further categorised by difficulty depending upon the difficulty level assigned to individual words included in the set of linked words as compared with other sets.

19. A computer-implemented method according to any one of claims 1 to 16, wherein selection of a set of linked words is based upon selection of a final linked word and the automatic selection of words having fewer letters and that are linked to the final linked word.

20. A computer-implemented method according to claim 19, wherein the plurality of words include multiple sets having the same final linked word and hence one of many different sets of linked words having the same final linked word is selectable for inclusion in the puzzle.

21. A computer-implemented method according to claim 20, wherein two or more different sets of linked words having the same final linked word are grouped together to form a multi-set of linked words, and in addition to selecting a final word for inclusion in the puzzle, a particular set of linked words within a multi-set is also selected.

22. A computer-implemented method according to either claim 20 or claim 21, wherein each set of linked words is further categorised by difficulty depending upon the difficulty level assigned to individual words included in the set of linked words as compared with other sets, and the selection of a final linked word for inclusion in the puzzle is based upon a difficulty category that is pre-selected by the user.

23. A computer-implemented method according to any one of the preceding claims, wherein there is more than one clue set associated with a single set of linked words, and when one or more words in a set of linked words has multiple identification clues associated therewith of varying assistance, a single set of linked words is categorised as having more than one difficulty level, and a clue set is selected based upon a difficulty category pre-selected by the user.

24. A computer-implemented method according to any one of the preceding claims, wherein determining a winner when there is more than one user competing in the word puzzle, or scoring a user's interaction with a puzzle, is based upon one or more of:
puzzle completion time;
completion of a puzzle using a minimum number of turns;
resignation by one or more opponents; and
difficulty associated with a set of linked words and/or clue set.

25. A computer-implemented method according to any one of the preceding claims, wherein the graphical user interface is configured to display the scoring associated with one or more competing user's interaction with a puzzle, including one or more of:
a current score;
a final score;
a high score;
a simulated score; and
a leader board.

26. A computer-implemented method according to any one of the preceding claims, further including: receiving a wager from the user; and on conclusion of the puzzle, allocate an award to the user based upon the user being successful in satisfying one or more puzzle requirements.

27. A computer-implemented method according to claim 26, wherein the award is based upon a quantum of the wager and/or a level of achievement in respect of the user's interaction with the puzzle that resulted in the award.

28. A computer-implemented method according to claim 27, wherein the award includes one or more of:
an award of credits; and
redeemable tokens.

29. A computer-implemented method according to claim 28, wherein the redeemable tokens are redeemable to assist a user in relation to solving a remaining portion of the puzzle, or a new puzzle.

30. A system or game controller for providing a word puzzle, the system or game controller including:
one or more memories, and
one or more processors operable to:
store, in an internal database that includes a data structure, a plurality of words that are categorized in the data structure according to the number of letters forming each word thereby enabling the plurality of words to be arranged in groups such that each word in the same group has the same number of letters, wherein:
each word includes one or more corresponding identification clues,
each word in one group is linked to at least one other word in a different group according to the words having a minimum number of letters arranged in a corresponding sequence,
each linked word having a letter count that increases sequentially by an increment of one letter from a first linked word associated with a first group of words with a minimum number of letters up to a final linked word associated with a final group of words with a maximum number of letters, each subsequent linked word beyond the first including one additional letter as compared with the preceding linked word, and
the subsequent linked word including all letters of the preceding linked word with one additional letter at the beginning, internally, or end thereof;
receive, from one or more user devices, a request to operate a word puzzle;
select, for inclusion in the word puzzle, a set of linked words which includes at least a first linked word and a final linked word;
provide, for display on the one or more user devices, a graphical user interface including:
empty letter fields associated with a number of words that corresponds with the number of words present in the selected set of linked words which includes the final linked word, and
an identification clue associated with one or more of the words included in the selected set of linked words to assist a user to identify each of the words and thereby spell each word by allocating letters to the empty letter fields.

31. A computer-readable medium having a plurality of instructions executable by one or more processors to:
store, in a database that includes an internal data structure, a plurality of words that are categorized in the data structure according to the number of letters forming each word thereby enabling the plurality of words to be arranged in groups such that each word in the same group has the same number of letters, wherein:
each word includes one or more corresponding identification clues,
each word in one group is linked to at least one other word in a different group according to the words having a minimum number of letters arranged in a corresponding sequence,
each linked word having a letter count that increases sequentially by an increment of one letter from a first linked word associated with a first group of words with a minimum number of letters up to a final linked word associated with a final group of words with a maximum number of letters, each subsequent linked word beyond the first including one additional letter as compared with the preceding linked word, and
the subsequent linked word including all letters of the preceding linked word with one additional letter at the beginning, internally, or end thereof;
receive, from one or more user devices, a request to operate a word puzzle;
select, for inclusion in the word puzzle, a set of linked words which includes at least a first linked word and a final linked word;
provide, for display on the one or more user devices, a graphical user interface including:
empty letter fields associated with a number of words that corresponds with the number of words present in the selected set of linked words which includes the final linked word, and
an identification clue associated with one or more of the words included in the selected set of linked words to assist a user to identify each of the words and thereby spell each word by allocating letters to the empty letter fields.

32. A gaming machine including:
a display;
a credit input mechanism operable to establish credits on the gaming machine, the credit input device including at least one a coin input slot and note collection device;
meters configured for monitoring credits established via the credit input mechanism and changes to the established credits due to play of the gaming machine;
a game play mechanism including a plurality of buttons configured for operation by a user to input a wager from the established credits and to initiate a play of a game; and
a game controller including a processor and memory storing game program code, the game controller executing the game program code stored in the memory and responsive to initiation of the play of the game with the game play mechanism to:
store, in an internal database that includes a data structure, a plurality of words that are categorized in the data structure according to the number of letters forming each word thereby enabling the plurality of words to be arranged in groups such that each word in the same group has the same number of letters, wherein:
each word includes one or more corresponding identification clues,
each word in one group is linked to at least one other word in a different group according to the words having a minimum number of letters arranged in a corresponding sequence,
each linked word having a letter count that increases sequentially by an increment of one letter from a first linked word associated with a first group of words with a minimum number of letters up to a final linked word associated with a final group of words with a maximum number of letters, each subsequent linked word beyond the first including one additional letter as compared with the preceding linked word, and
the subsequent linked word including all letters of the preceding linked word with one additional letter at the beginning, internally, or end thereof;
receive, via the game play mechanism, a request to operate a word puzzle;
select, for inclusion in the word puzzle using a random puzzle selector, a set of linked words which includes at least a first linked word and a final linked word;
provide, on the display, a graphical user interface including:
empty letter fields associated with a number of words that corresponds with the number of words present in the selected set of linked words which includes the final linked word, and
an identification clue associated with one or more of the words included in the selected set of linked words to assist a user to identify each of the words and thereby spell each word by allocating letters to the empty letter fields.

33. A gaming device including:
a display;
a credit input means operable to establish credits on the gaming device;
a means of monitoring credits established via the credit input means and changes to the established credits due to play of the gaming device;
a game play mechanism configured for operation by a user to input a wager from the established credits and to initiate a play of a game; and
a game controller including a processor and memory storing game program code, the game controller executing the game program code stored in the memory and responsive to initiation of the play of the game with the game play mechanism to:
store, in an internal database that includes a data structure, a plurality of words that are categorized in the data structure according to the number of letters forming each word thereby enabling the plurality of words to be arranged in groups such that each word in the same group has the same number of letters, wherein:
each word includes one or more corresponding identification clues,
each word in one group is linked to at least one other word in a different group according to the words having a minimum number of letters arranged in a corresponding sequence,
each linked word having a letter count that increases sequentially by an increment of one letter from a first linked word associated with a first group of words with a minimum number of letters up to a final linked word associated with a final group of words with a maximum number of letters, each subsequent linked word beyond the first including one additional letter as compared with the preceding linked word, and
the subsequent linked word including all letters of the preceding linked word with one additional letter at the beginning, internally, or end thereof;
receive, via the game play mechanism, a request to operate a word puzzle;
select, for inclusion in the word puzzle using a random puzzle selector, a set of linked words which includes at least a first linked word and a final linked word; and
provide, on the display, a graphical user interface including:
empty letter fields associated with a number of words that corresponds with the number of words present in the selected set of linked words which includes the final linked word, and
an identification clue associated with one or more of the words included in the selected set of linked words to assist a user to identify each of the words and thereby spell each word by allocating letters to the empty letter fields.
